(19) United States
(12) Patent Application Publication
(10) Pub. No.: US 2002/0093673 A1
(43) Pub. Date: Jul. 18, 2002

(54) System and method for fulfilling information requests

(76) Inventors: Irving R. Safra, Huntingdon Valley, PA (US); Gary S. Rosner, Dresher, PA (US)

Correspondence Address: REED SMITH LLP, 2500 ONE LIBERTY PLACE, 1650 MARKET STREET, PHILADELPHIA, PA, 19103, US

(21) Appl. No.: 09/760,947

(22) Filed: Jan. 16, 2001

(51) Int. Cl. G06F 15/00; B41J 1/00

(52) U.S. Cl. 358/1.15

(57) ABSTRACT

The present invention is a system and method for increasing the ease with which representatives of an organization can request documents or assist clients or customers in requesting documents, remotely from an office wherein the system and method are based on the implementation of a document request device provided with a wireless communications path to a central station, the document request device allowing a representative to be prompted to identify relevant information needed to fulfill a document request, the wireless communications path allowing a document request to be transmitted from the document request device to a central station, and the central station processing document requests to ensure fulfillment of the document request.

### FIELD OF THE INVENTION

The present invention pertains to the rapid provision, of documentary material to customers, and more particularly, to the rapid distribution of requested material by a means such as facsimile transmission, such request being made to a representative, allowing the representative to confirm receipt of the document request.

### BACKGROUND OF THE INVENTION

The ability to provide customers with rapid responses to information demands has been critical to promoting and effectuating business for a long time. To this end, many methods of providing information to customers have been used, including providing fax back systems.

Fax back systems allow a customer, either potential or pre-existing, to call a telephone number, and select a document from a list verbalized to the customer. A copy of the selected item is then faxed back to the customer at a fax number provided by the potential customer.

Later developments allowed the requested document to be tailored to the specific entity requesting the document. For example, if the document involved geographically dependant rates, the location of the caller could be determined using a technology such as caller-id to identify the number from which the document request was placed, and thus the geographic location of the caller.

While these systems have improved the ability of businesses to distribute documentary material upon request, the systems are dependant upon the customers themselves initiating the document requests. In order to allow information to be disseminated during the visit of a company representative, salesman, or deliveryman (hereafter collectively referred to as “representatives”), the representative would have to carry copies of each document that a customer could request during the visit. In addition to the physical effort required to transport the potentially large number of documents, the use of representative delivered documents created large logistical problems. Each representative would have copies of each document, with each document having to be periodically updated. When updates occurred, the large inventory of documents carried by the representatives would have to be sorted through by the representative to identify documents being replaced, the replaced documents would have to be thrown away, and the new documents inserted into the document inventory. Since each representative would have had a copy of the replaced document, the number of documents being wasted adversely impacted the cost of doing business.

Alternately, some documents are restricted by regulation, such that representatives can not carry the documents. These documents may have to be distributed directly from a central point, such that a representative has to accumulate requests while “out of the office”, and submit the requests when the representative is back in the office.

It is thus a goal of the present invention to provide a system whereby representatives of a business can assist customers to acquire required documents from the representative in a rapid fashion, without requiring the representative to transport large numbers of documents. It is a further goal of the invention that the system allow the representative to receive feedback regarding the delivery of a document. It is also a goal of the present invention to reduce the effort associated with ensuring the currency of the available documents which can be distributed by an representative. Finally, it is a goal of the present invention to simplify the notification of third parties of the delivery of documents, by incorporating a reporting system into a remote document request system.

### SUMMARY OF THE INVENTION

The present invention is a system and method allowing documents to be provided by representatives of an entity while the representatives are remote from their offices.

The system of the present invention may include at least one document request device. The request device serves as an input device and a wireless transmitter. The system also includes a central station. The central station stores or enables access to a plurality of requestable documents. The central station may also include a receiver, a means for delivering documents, and a processor.

The wireless transmitter is communicably connected to the central station receiver, and broadcasts information requesting delivery of a requestable document in response to input entered into the document request device.

The process associated with the document fulfillment system comprises the steps of identifying to a document request device a document being requested, and identifying to the document request device a delivery destination for delivering the document being requested. A delivery method for transmitting the desired document to the delivery destination is determined by identifying a method to the document request device. The information comprising the request is then transmitted to a central, said transmission utilizing a wireless transmission from the document request device. When the document request is received at a central station, the central station transmits to the document request device a verification that the document request has been received, and transmits the requested document to the requester.

The system and method may also include a capability to modify documents for transmission to customize the documents based on information associated with a document request, such as a destination address, requester or representative identity. Alternately, the system and method may be implemented such as to prevent the modification of a document, such that certifications can be made that a transmitted document complied with a regulatory requirement for fixation.

The system and method may further include a capability to provide reports regarding the distribution of a document to a third party. The system may utilize document delivery means organic to the document delivery system to disseminate reports to third parties regarding distribution of a document, such as notifying a control entity of the delivery of a controlled document. The method of the present invention may incorporate this step by including reporting requirements information as part of document storage, such that delivery of a document having a reporting requirement may trigger the generation of a report to a third party.

### BRIEF DESCRIPTION OF THE DRAWINGS

FIG. 1 shows a document delivery system according to the present invention.

FIG. 2 illustrates a document request device as used with the present invention.

FIG. 3A shows an illustrative process flowchart, as it involves a document request device, embodying the method of the present invention, wherein a determination of whether a certification is required for document delivery is accomplished by reference to information internal to a document request device.

FIG. 3B shows an illustrative process flowchart, wherein a determination of whether a certification is required for document delivery is accomplished by reference to the central station.

FIG. 4 shows an illustrative process flowchart, as it involves a document request central station, embodying the method of the present invention.

FIGS. 5A-5G show illustrative examples of a document request device display as used with a simplified document request system implemented in a pharmaceutical industry application.

### DETAILED DESCRIPTION OF THE INVENTION

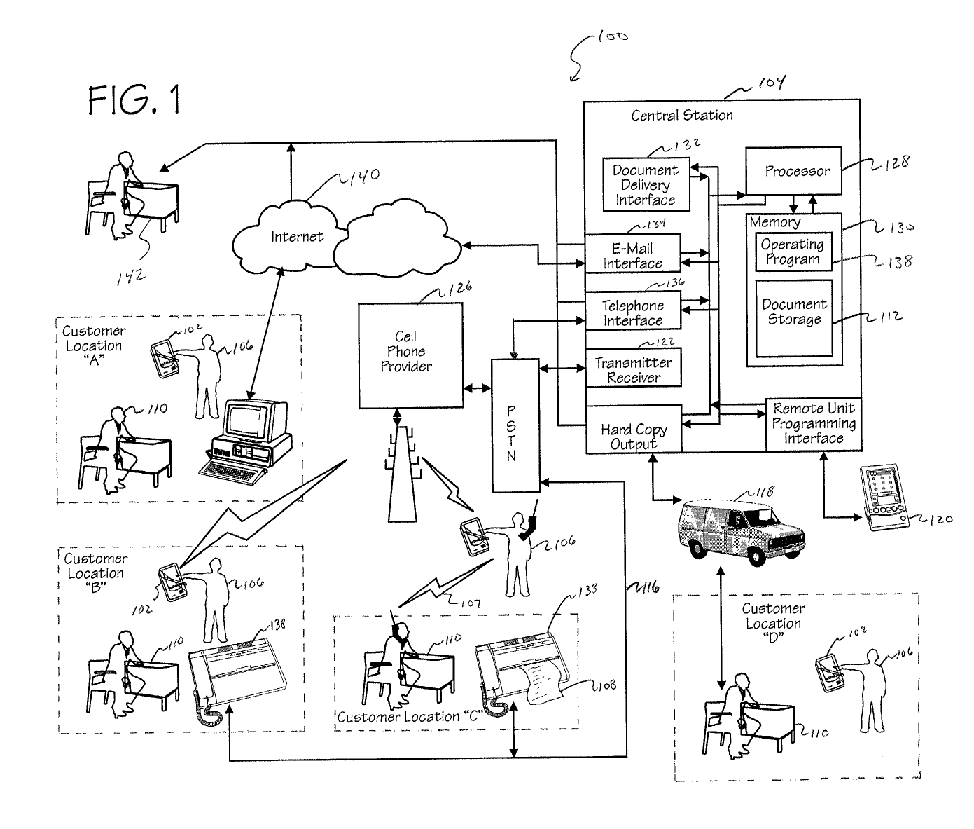

In the figures there is shown an embodiment of the present invention, wherein like numerals indicate like elements. In FIG. 1 there is shown the general components of a document delivery system (hereafter “DDS”) 100 for fulfilling information embodying the present invention. The embodiment is illustrated with a single business entity operating each aspect of the system, although different elements of the system could be operated by different business entities, working cooperatively, or on a service basis. A document request device (hereafter “DRD”) 102 is communicably connected with a central station 104. The DRD 102 may be carried by a representative 106 of the entity desiring to distribute documents. The representative 106 may be an employee of the entity, or a contractor or sub-contractor of the entity, an employee of a document distribution service, a contractor or subcontractor thereof, or any other person utilizing the DRD 102 to offer document distribution. Representatives 106 may also include other people, such as sales representatives, or delivery personnel.

The term “document” as used herein refers to a unit of information. Although document in its ordinary usage may have the connotation of being a piece of paper on which an image is displayed, this limitation is not contemplated herein. The term “document” is used herein to refer to information available to be requested. Documents as contemplated herein may comprise, but are not limited to, textual or visual images on a medium such as paper, and electronic representations of information including text, images, or sounds. The electronic representations may be computer readable data, either recorded onto a storage media or embodied in a stream of data. Although the presently described embodiment is directed towards documents which are viewable by a requester, the requested document can take forms as described above, such as an electronic key to enable software, new software itself, or data to be used by existing software. The document may also contain non-visual material, such as a digitally encoded audio file or video file.

Whether a representative is at a requester's location, or remote from the location but in communication 107 with the requester, a representative 106 holding the DRD 102 can receive a request for a document 108 from the requester 110. A requester may be a third party desiring a document, or may be the representative him or herself. The document request is entered into the DRD 102, and transmitted to the central station 104 via a radio frequency transmission such as a cell phone connection, pager connection, satellite cellular connection, or standard radio transmission. The central station 104 receives the request, retrieves the requested document from an internal document storage 112, and then transmits the document 108 to the requester 110, such as by Internet e-mail 114, fax transmission 116, or by mail or courier service 118 if the requestor 110 so indicates. The central station 104 may also personalize or customize the document before transmitting the document 108.

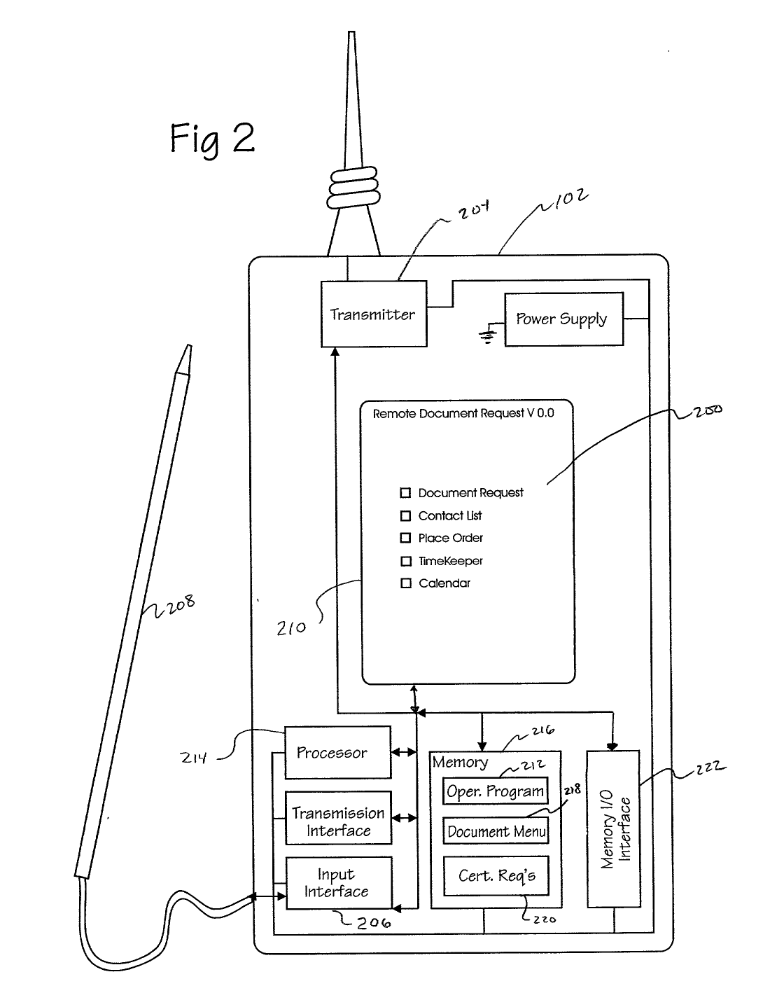

The DRD 102 of the present invention may be a modification of an application specific device, such as a parcel service package tracking and signature unit, a custom unit designed specifically for the document request system, or a device such as a personal data assistant (hereafter “PDA”). As shown in FIG. 2, the DRD 102 preferably includes an information display 200, and a transmitter 204. Although many input means 206 may be adapted to allow the DRD 102 of the present invention to gather information, it is presently preferred to use a pointing device such as a stylus 208 in connection with a touch sensitive flat panel display 210. The use of a stylus 208 allows signatures to be collected and stored by the DRD 102, as well as the selection of documents being requested and the provision of document destination information.

The flat panel display 210 is preferably able to display a graphical user interface that is reconfigurable by an operating program 212 installed in the remote unit. The use of reconfigurable displays is known in the art. By utilizing reconfigurable displays, the display can present different input screens, such as screens for identifying the requesting customer, shown in an exemplary illustration below in relation to example 1, screens for identifying a desired document, shown in an exemplary illustration below in relation to example 1, or a screen for certifying the customer request, also shown in an exemplary illustration below in relation to example 1. Also, the flat panel display 210 can be programmed to show document delivery status, shown in an exemplary illustration below in relation to example 1.

The DRD preferably also includes a processor 214 and memory 216 that allow an operating program 212 to be stored in the DRD 102. The operating program 212 defines the functionality of the DRD 102, including instructions for generating displays on the flat panel display 210. The memory 216 also may contain a document menu 218, identifying documents available for delivery, and certifications requirements listings 220, identifying what certifications may be required before a document 108 may be transmitted.

The DRD 102 also preferably includes a memory input/output interface 222, such that the operating instructions, document menus, and certification requirements may be transferred to the DRD memory 216 from an outside source. Methods for communicating operating instructions, document menus, and certification requirements to the unit are commonly known, and include, but are not limited to, the use of docking stations, IR transfers, and replaceable memory units. Alternatively, this information can be transmitted from the central station to the DRD 102 via the same communications path established between the DRD 102 and the central station 104 for making document requests. The memory input/output interface 222 may be a connection for communicably connecting the DRD 102 with a docking station 120 (shown in FIG. 1), allowing information to be transferred directly from a central station 104. The interface 222 may alternately be a device such as a removable disk drive, such as a floppy disk. Alternately, the memory itself may be in the form of a removable memory unit, such as a floppy disk or read-only-memory chip, allowing the operating instructions, document menu, and certification information to be provided by the installation of the removable memory unit into the DRD 102.

The central station 104, as shown in FIG. 1 is preferably a computer or server or a group of computers or servers (hereinafter referred to generically as a computer). A group of computers can be used with different computers performing different functions, or several computers providing the same function to provide adequate capacity to meet demand. For example, one computer can act as a process control server, responsible for receiving document requests, and forwarding the document requests to another computer, such as a file server, which is responsible for maintaining documents. Additionally, other computers could perform the function of document delivery servers, such as one server being responsible for e-mail transmissions, a second computer being responsible for facsimile transmissions.

The central station includes a transmitter/receiver 120 for receiving document requests from DRD's 102, and for transmitting document request verifications to a DRD 102. The transmitter/receiver 122 may be a connection to a publicly switched telephone line 124, such that a third party provides radio frequency transmission of information between a DRD 102 and a central station.

More specifically, if the remote units are utilizing a cellular transmission frequency, a cellular phone provider (carrier) 126 would receive the document requests through the cellular carrier's cellular network 128. The received document request would be forwarded to the central station 104 by the PSTN 124, or could be retransmitted by the cellular carrier 126 to the central station 104 utilizing a cellular frequency retransmission (not shown). Although the illustrated embodiment may utilize third party retransmission, the use of the third party retransmission responsibility is based on using the efficiencies inherent in the cellular carrier's provision of services to a large number of users, and not based on a direct effect on the present system. Alternately, satellite cellular or pager technologies (not shown) can be utilized for communicating the document request from the DRD 102 to the central station 104, with attendant potentials for using third party carriers for responsibility for the basic communications infrastructure.

As an alternative to using cellular transmission methods, where the remote units are deployed within a fixed area, normal radio transmission techniques (not shown) can be used, employing a radio frequency transmitter/receiver associated with each remote unit, as well as a transmitter/receiver associated with the central station. The use of normal radio transmissions may also utilize relay stations between the remote unit and the central station, and such relays may or may not be associated with the central station.

The central station may also include a processor 128, memory 130, a document delivery interface 132, and a document transmission device, such as an e-mail interface 134 or a telephone interface 136. The memory 130 includes operating software 138, which provides operating instructions for the processor 128 to receive and act upon document requests received from a remote unit 102. The operating software 136 includes logic dependant on the documents to be delivered, and upon any requirements for document delivery, such as the requirement that a customer signature be on file before a document can be delivered to a customer.

The delivery of documents may be any known method for delivering a copy of the document to the customer. The document delivery method may be by a standard fax transmission such that in information received from the document delivery interface 132 is converted into a signal which is transmitted to a customer over publicly switched telephone lines 124 and received by a facsimile machine 138, or via Internet delivery of the fax. Alternately, if the document delivery is via e-mail or file transfer, the document delivery method would convert information received from the document delivery interface 132 into a signal which is transmitted over a computer network such as the Internet 140. Document delivery may also be accomplished by generation of a physical copy of the requested document, with the physical copy being transmitted to the requester via mail or express courier 118.

The central station 104 also includes a document storage means 112. The document storage means 112 in the central station 104 preferably consists of electronic memory associated with the central station 104, and may be the same memory that the operating software is stored in. The documents 108 may be stored as image files, or as editable document files.

Image files may consist of a digital representation of the image, and may be in any format compatible with the document delivery interface. When a document 108 is identified as being requested by a customer 110, the processor 126 informs the document delivery interface 130 of the identity of the document. The document delivery interface 132 retrieves the document file from memory 130, and converts it into a format compatible with the document delivery method requested. The functions of the document delivery interface 132 may be accomplished by the processor 128 itself, resulting in a system which does not require a discrete document delivery interface 132.

Alternately, the documents may be stored in an editable format, such that the processor can modify the content of the document to tailor the content to the specific customer 110 requesting the document 108. Modification may consist of personalizing the document according to who the requester is, or customizing the document based on the particular circumstances of the document request. A document could be both personalized and modified. For example, the available documents could include form letters from a business entity, such that when the document is requested, the document is modified to include a personal greeting to the requester, as well as incorporate a rate quote based on the geographic location of the requester.

The operating instructions for the central station may also incorporate a capability to provide reports to third parties 142 when documents 108 are transmitted. The third party 142 may be an organization related to the document delivery system 100, such as a follow-up representative with the responsibility of making a follow-up call regarding the document, or may be an organization which controls distribution of the delivered document 108, such as a regulatory body. When a report should be made, the report may be transmitted to the third party 142 utilizing the document delivery means present in the document delivery system, such as via e-mail, fax, or hard copy document delivery. Additionally, the document delivery system 100 may provide such reports either each time a relevant document is delivered, or may accumulate data regarding specific documents for reporting to the third party in a periodic report.

Document Delivery Process

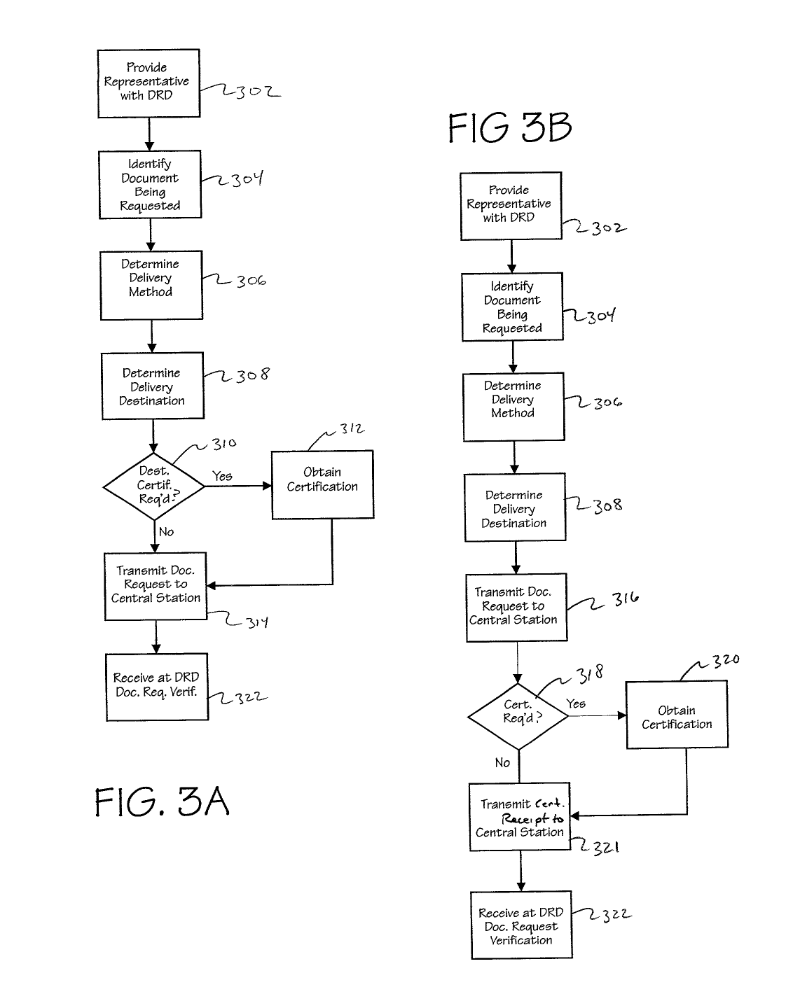

In FIG. 3A, there is shown a process flowchart for a method of providing documents according to the present invention. The first step is to provide 302 at least one representative with a DRD.

As is evident from the above description of the described system, a potential requester can make his or her desires known to a representative either in the representatives presence, or by calling the representative, or a request can be made by the representative him or herself. Once a potential requester indicates a desire to receive a document, the identity of the document being requested is determined 304. The document determination is preferably made by informing the requester of what documents are available, from which the requester is able to select the desired document. It is presently preferred that the list be presented to a potential requester through menus which assist a representative in identifying documents available for the potential requester. Such a menu structure is described further below.

The delivery method for delivering the requested document is then determined 306. Since document delivery can be by alternate methods, including but not limited to, mail, express courier, fax, e-mail, and file transfer, it is preferred to offer the requester with a list of potential delivery methods, from which the requester can select the desired delivery method. Again, presenting this list may be accomplished by displaying a list or menu structure to the representative, who can assist a requester in identifying a desired delivery method.

Once the delivery method has been determined, the delivery destination is determined 308. Since the address format for each delivery method may differ, the DRD preferably prompts a user for the correct delivery destination address. For example, if the delivery is to be by fax transmission, the DRD can prompt for the entry of a fax number. If the delivery method is by mail or express courier, the DRD may prompt the user for a delivery address, including street, town, and zip code information. In the case of an express courier, the DRD may also prompt for a telephone number at the delivery address, such as required my some express courier services.

The DRD may next determine whether a requester certification is required 310. The determination of whether a requester certification may be accomplished by reference to information contained in the memory of the DRD, or by transmitting the document identification to the central station, and receiving an indication from the central station of whether the certification is required.

If reference is made to internal memory, shown in FIG. 3A, the determination of whether certification is required may be made before the document request is transmitted 314 to the central station. If certification is required, the DRD may be prompted to obtain 312 a requester certification before initiating the document transmission to the requester. The certification may take the form of requiring the requester to provide a signature to the DRD, i.e., sign on an input device of the DRD which digitizes the signature, or may allow the user of the DRD to conduct a certification procedure, such as by examination of identification of the requester.

If reference must be made to information maintained by the central station, the determination of whether certification is required may be made after the document request is transmitted 316 to the central station, as shown in FIG. 3B. The central station may make the determination 318 whether certification is required, and inform the representative to obtain 320 a certification. Receipt of the certification may then be transmitted 321 to the central station.

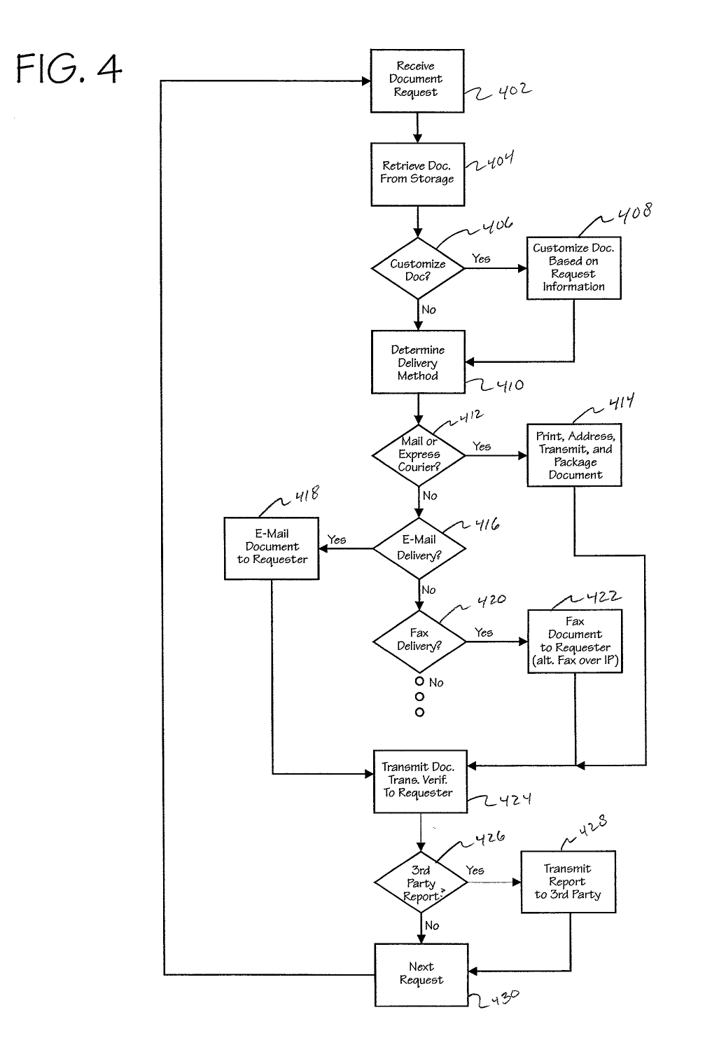

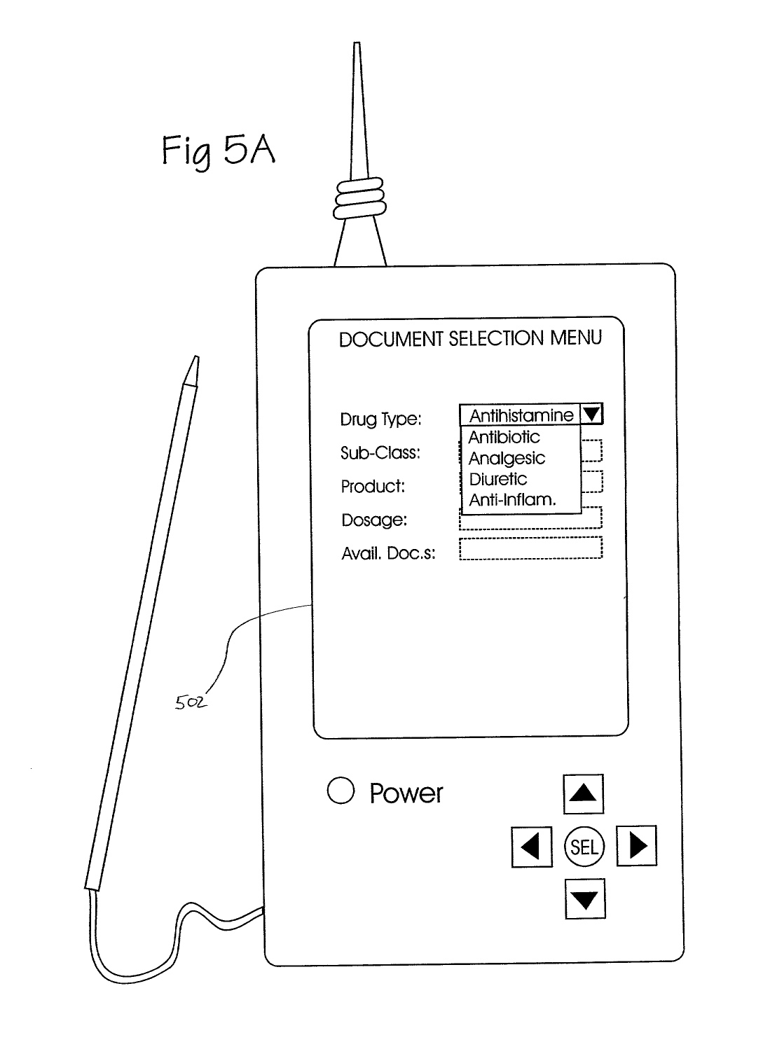

Returning to FIG. 3A, once the certification has been obtained, or it is determined that no certification is required, the DRD transmits 314 the document request to the central station. As shown in FIG. 4, the central station receives 402 the document request, and retrieves 404 the requested document and any associated information from storage. The storage, as described above, is preferably memory associated with a computer, such that the document is stored as an image file, text file, or other format allowing delivery of the document by the delivery methods supported by the central station. The central station may then determine 406 whether the document should be customized from associated information, and if amenable to customization, customized 408 based on the requester information, such as identity, delivery address, or delivery method.

Once the document is ready for transmission, the central station determines 410 the desired delivery method, such as through an iterative process. If it is determined 412 that the requester has requested that the document be delivered through the mail or an express courier service, the central station may print, package, and address 414 the document for transmission to the requester. If it is determined 416 that the desired delivery method is via e-mail, the central station may transmit 418 the document to the requester via e-mail. If it is determined 420 that the requester desires that the document be delivered by fax, the central station may fax 422 the document to the requester. Each of the delivery methods may alternately be handled by outsourcing the task, such as by contracting to have a fax delivery service transmit the fax upon request of the central station.

Either before or after transmitting the document to a requester, the central station may transmit 424 a confirmation to the DRD. Returning to FIG. 3, this confirmation is received 322 by the DRD, such that the requester can be informed of the confirmation.

If the DRD does not include information noting whether a certification is required, the DRD, as shown in FIG. 3, may first transmit 316 the document request to the central station, at which point the central station may make a determination 318 of whether a certification is required. If required, the central station may inform the DRD of the need to obtain a certification by transmitting the certification requirement to the DRD. At this point, the DRD may obtain 320 a needed requester certification. Certifications may consist of requiring a requestor to provide identification, such as a user name and a password, or requiring a representative to obtain a signature from the requester, where the signature indicates acceptance of the terms of the document being transmitted to the requester. Alternately, a representative may be required to verify the identity of the requester, such as by examination of a license or other identifier.

Additionally, as shown in FIG. 4, the central station can make a determination 426 as to whether the document delivery should be reported to a third party. This determination may be based on information associated with a particular document, a particular group of documents, or based on the identity of the representative or destination of the document. Once it has been determined 426 that a report should be made to a third party, the central station can generate and transmit 428 the report to the third party. Reports can be based on either individual document deliveries, or can be based on aggregated delivery information, such as the number of a particular document delivered within a given time period, including other business information such as for example geographic destination groupings. Reports based on individual document deliveries may be utilized to initiate follow up services, such as providing information to a follow-up representative that a particular requester requested information on a particular subject, allowing the follow-up representative to later call the requester regarding the contents of the document.

First Exemplary Application

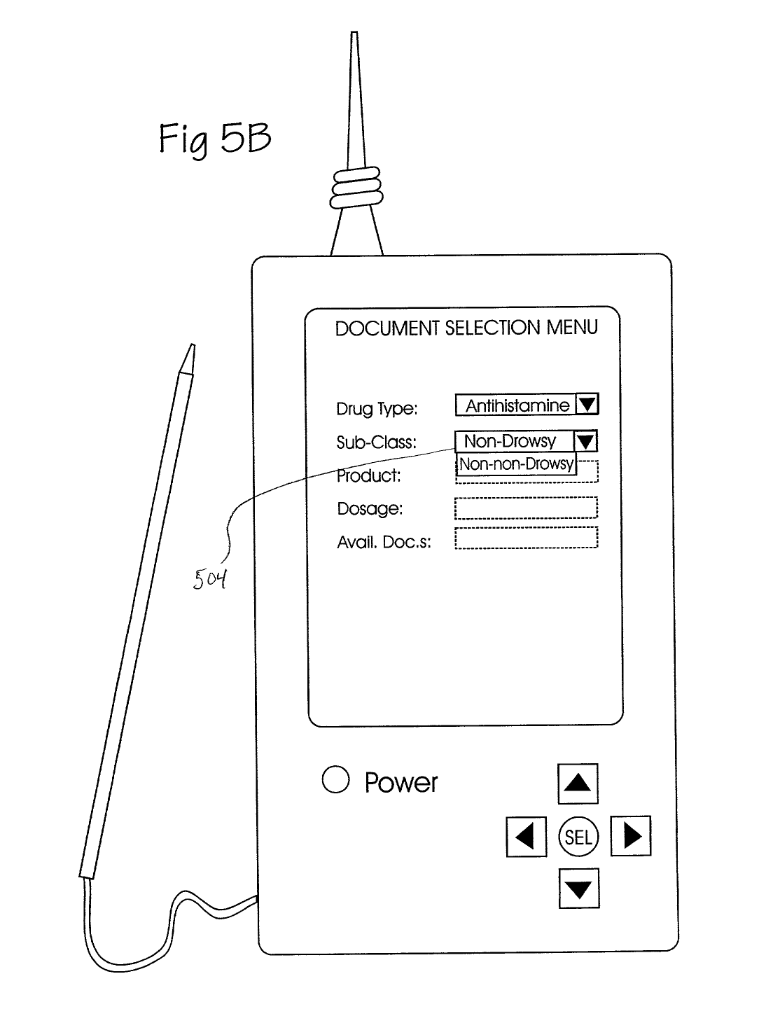

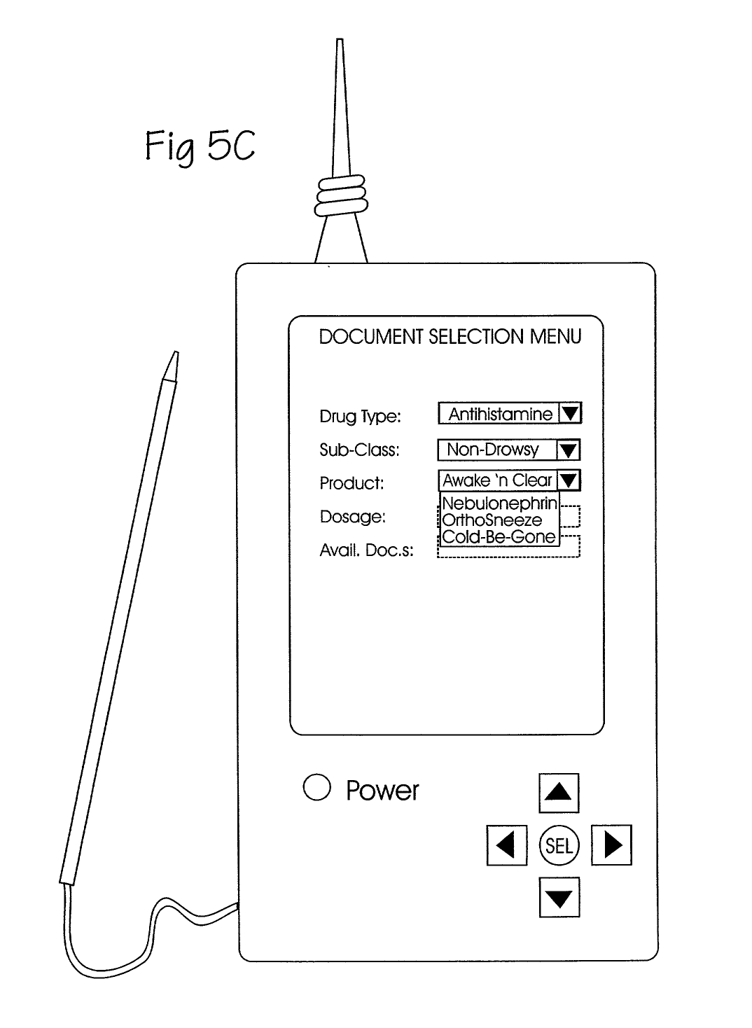

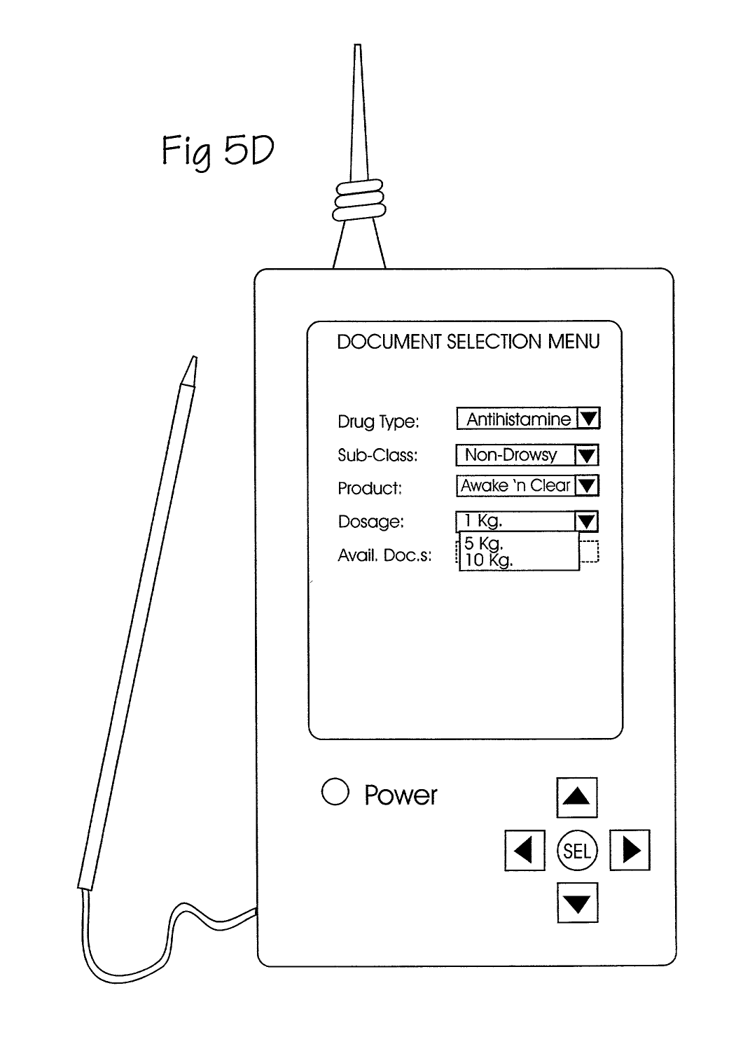

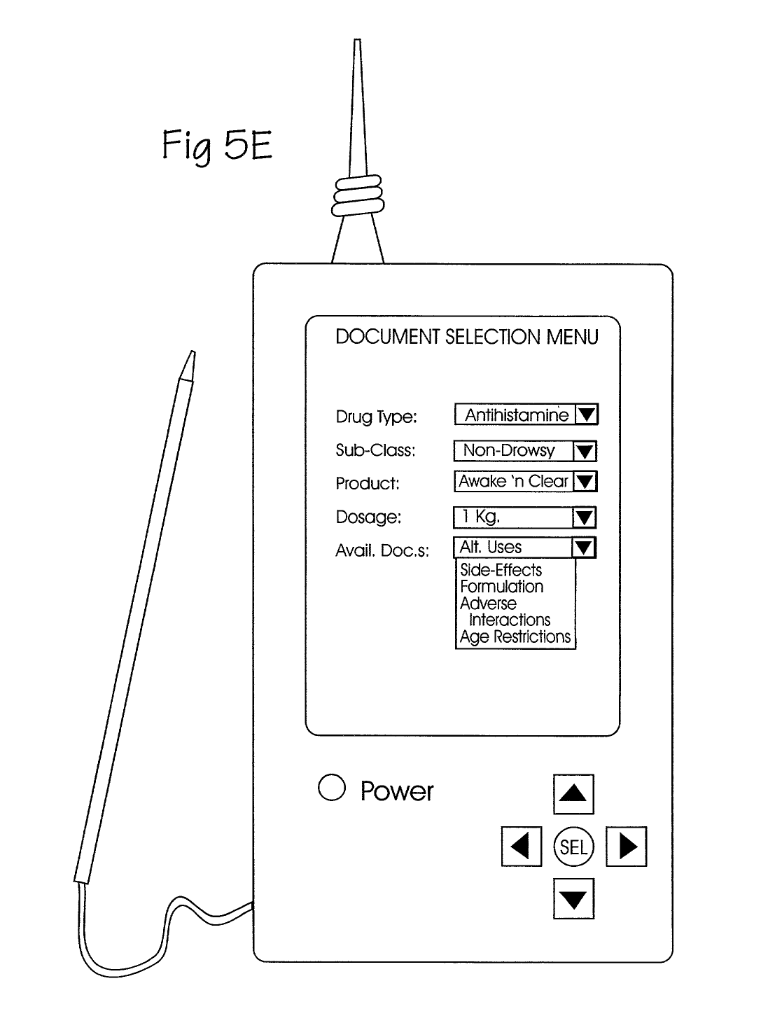

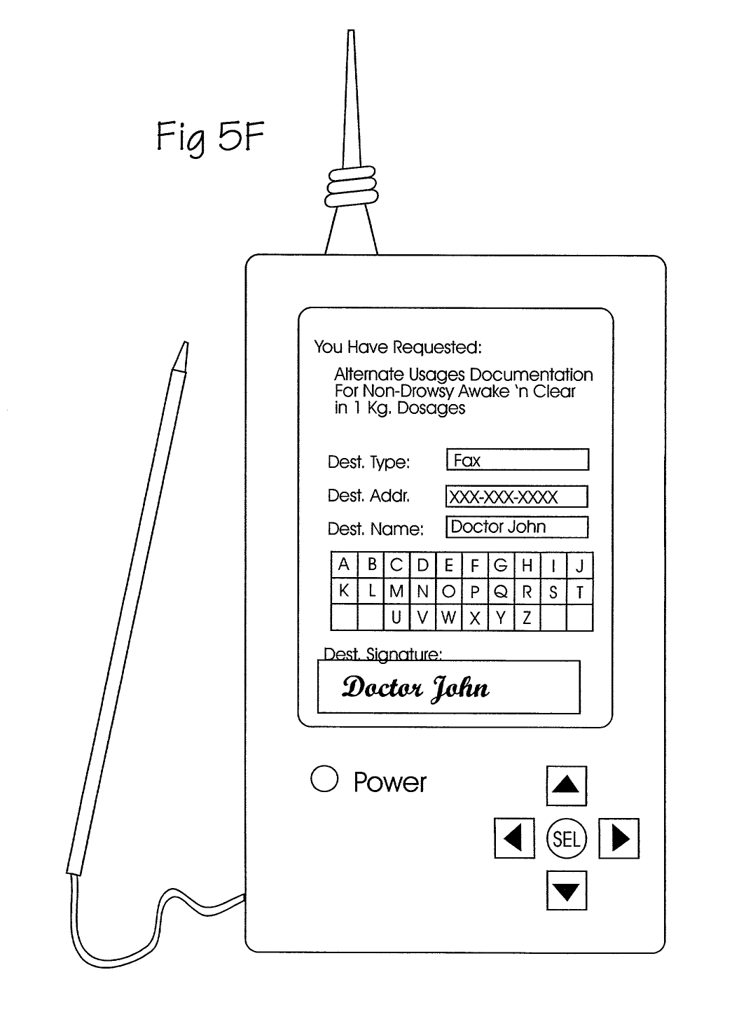

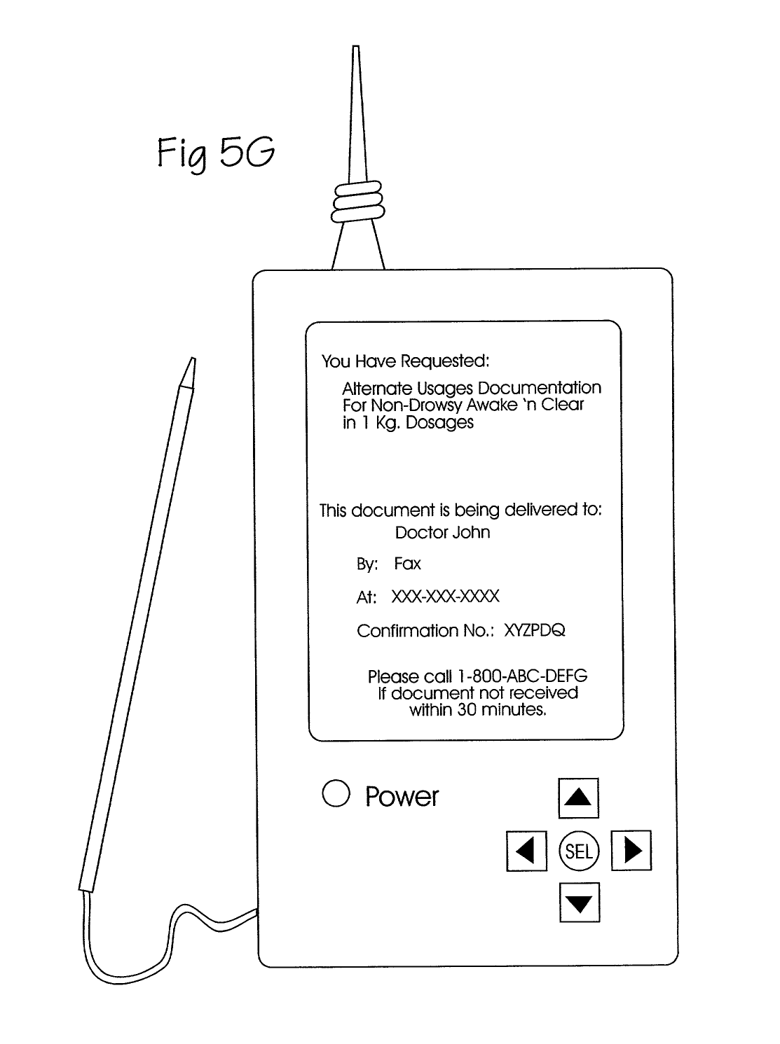

In the following illustrative example of an implementation of the present invention, the remote unit may comprise a customized hand-held unit carried by a representative of a pharmaceutical company as shown in exemplary form in FIGS. 5A-5G. In making calls to physicians responsible for prescribing drugs, the representative may desire to offer the physicians visited copies of literature regarding products offered by the pharmaceutical company represented by the representative. For the example, restrictions are in place, either from the pharmaceutical manufacturer or a third party, requiring that the requestor of the literature provide a signature certifying that the literature was requested by a physician. To meet this requirement, the remote unit could have a re-configurable display integrated with a touch screen, such that in addition to pull down menus for selecting requested literature, the representative could acquire an electronically digitized signature as a proof of the identity of the requestor.

The remote unit for such an application could be based on a pull-down menu system, allowing documents to be identified by successively narrower selections from product categories and identifications. For example, high level categories 502 could include antibiotics, antihistamines, and pain killers, shown in FIG. 5A. Selecting antihistamines would result in a second pull down menu 504 being displayed, shown in FIG. 5B, with sub-selections from within antihistamines including non-drowsy formulations being presented to the DRD user for selection. Additional selection criteria may be incorporated in additional pull down menus, such as those shown in FIG. 5C and FIG. 5D. This narrowing definition allows a list of available documents to be generated based on the higher level selections of the requester, as shown in FIG. 5E. Once the document has been identified, the DRD can prompt for and receive information relating to the delivery method, delivery destination, and, if required, a certification from the requester such as a signature, as shown in FIG. 5F. Finally, the DRD can display a verification of the document request, as shown in FIG. 5G. In this scenario, the central station could also provide information to an entity requiring certification of the document request, and certification obtained, as part of the process of delivering the document.

Second Exemplary Application

A second application for which the present system may be implemented is the inclusion of the functionality within an existing system, such as a package tracking and delivery system. These systems are presently in use by such organizations as United Parcel Service, and Federal Express courier service. The delivery personnel for the package delivery services may carry a device designed for document tracking functions, such as entry of a customer receipt signature, and transmission of package delivery information to a central station. By implementing the document request functionality within the existing tracking devices carried by the delivery personnel, the delivery personnel become capable of meeting document requests for information related to package delivery services, such as generating tracking histories for packages for which a customer has an interest.

Tracking histories can presently be obtained over the internet, or via a telephone request to a service representative of the package delivery service. These existing methods require the customer to make the request utilizing the customers own equipment and initiative. Making a phone-in request can be cumbersome, where delays before talking to a customer service representative exist. Other customers may not have computer equipment to allow them to initiate such a request over the Internet. When a delivery person arrives with the days deliveries, a customer can request the tracking history from the delivery person when the customer realizes an expected package has yet to arrive. Other requestable information may include rate information, service guarantees, or delivery service employment information.

Third Exemplary Application

The document request system described above may also be utilized to improve the ability of traveling representatives to provide communications to their clients or customers. In this embodiment, the representative may initiate his or her own document requests.

The documents stored for transmission may include form letters to which customizing or personalizing information may be added. As such, a traveling representative could request delivery of an order confirmation letter to a customer, adding customer, item, quantity and cost information into a thank you letter, while the traveling salesman sits in the parking lot of the customers location. As such, the representative could ensure that documents related to customer relations could be sent in any form from the representative to the customer immediately after the representative's visit to the customer. Also, the representative may receive a call from a client while the representative is on the road, and be able to generate transmission of a document to the customer based on the conversation.

As is apparent from the above discussion, the present invention may be embodied in other specific form-s without departing from the spirit or essential attributes of the invention. Accordingly, reference should be made to the appended claims, rather than the foregoing specification, as indicating the scope of the invention.

What is claimed is:

1. A remotely initiated document request fulfillment system, comprising:
at least one document request device, the at least one document request device comprising an input device and a wireless transmitter;
a central station, the central station comprising a plurality of requestable documents, a receiver, and a document deliverer, wherein said document deliverer transmits at least one requested document to a destination according to at least one instruction of the processor, wherein the at least one instruction is according to the at least one document request communicably received at the receiver from the transmitter.

2. A remotely initiated document request fulfillment system according to claim 1, wherein the wireless transmitter comprises a transmitter in communication with a cellular telephone network.

3. A remotely initiated document request fulfillment system according to claim 1, wherein the wireless transmitter comprises a transmitter in communication with a satellite cellular telephone network.

4. A remotely initiated document request fulfillment system according to claim 1, wherein the wireless transmitter comprises a radio frequency transmitter, and the central station receiver comprises a radio frequency receiver, wherein said wireless transmitter transmits on a frequency which is receivable by the central station receiver.

5. A remotely initiated document request fulfillment system according to claim 1, wherein the document request device further comprises a display device, said display device for displaying information regarding documents available for request, said display device further issuing at least one user prompt to enter information identifying a destination for a requested document.

6. A remotely initiated document request fulfillment system according to claim 5, wherein the display device comprises a touch sensitive flat panel display, said touch sensitive flat panel display receiving input through contact between a surface of the display and a pointer.

7. A remotely initiated document request fulfillment system according to claim 6, wherein the pointer is a stylus.

8. A remotely initiated document request fulfillment system according to claim 6, wherein the pointer is a finger of an operator.

9. A remotely initiated document request fulfillment system according to claim 1, wherein the document deliverer comprises a facsimile transmitter.

10. A remotely initiated document request fulfillment system according to claim 1, wherein the document deliverer comprises a means for generating a copy of a requested document, and transmitting the copy of a document to a requester via a mail service.

11. A remotely initiated document request fulfillment system according to claim 1, wherein the document deliverer comprises at least one connection between the central station and the Internet, and a means for generating an e-mail transmission including a copy of a requested document.

12. A remotely initiated document request fulfillment system according to claim 1, wherein the central station is capable of modifying a requestable document based on information associated with a request.

13. A remotely initiated document request fulfillment system according to claim 12, wherein the information is at least one geographic location to which the document is to be delivered.

14. A remotely initiated document request fulfillment system according to claim 12, wherein the information associated with a request is the identity of an entity to which the document is to be delivered.

15. A remotely initiated document request fulfillment system according to claim 12, wherein the information associated with a request describes a transaction between a requester and a representative.

16. A remotely initiated document request fulfillment system according to claim 1, wherein the document request device further comprises memory, said memory for storing an operating program for the document request device, and information identifying requestable documents.

17. A remotely initiated document request fulfillment system according to claim 16, wherein the document request device memory is further capable of storing information identifying whether certification is required before a requested document can be transmitted to a requester.

18. A remotely initiated document request fulfillment system according to claim 16, wherein the document request device further comprises an interface for receiving updated operating program information, said updated information identifying requestable documents.

19. A remotely initiated document request fulfillment system according to claim 1, wherein the document deliverer further transmits a report to a third party, said report informing the third party of the transmission of a requested document.

20. A remotely initiated document fulfillment system, comprising:
at least one programmable document request device, the at least one programmable document request device including memory, a processor, a reconfigurable display, an input means, a document request device wireless transceiver, and a document request system operating program;
a central station, the central station including a plurality of requestable documents, a central station wireless transceiver, and a document delivery means, said document delivery means for transmitting a requested document to a destination;
wherein the document request device wireless transceiver of the at least one document request device is communicably connected to the central station wireless transceiver, said document request device wireless transceiver broadcasting information requesting delivery of a requestable document in response to input entered into the document request device.

21. A remotely initiated document fulfillment system according to claim 20, wherein a list of requestable documents is stored in the document request device memory.

22. A remotely initiated document fulfillment system according to claim 21, wherein the requestable documents include documents which by regulation may not be distributed by a representative.

23. A remotely initiated document fulfillment system according to claim 22, wherein the document delivery means is further for transmitting a report to a third party when a document which by regulation may not be distributed by a representative is transmitted to a destination.

24. A remotely initiated document fulfillment system according to claim 21, wherein the requestable documents include documents which are modifiable by the central station.

25. A remotely initiated document fulfillment system according to claim 24, wherein the modifiable documents include business documents, said business documents being modifiable based on information associated with a document request.

26. A remotely initiated document fulfillment system according to claim 25, wherein the information associated with a document request includes the identity of a representative requesting a document.

27. A remotely initiated document fulfillment system according to claim 25, wherein the information associated with a document request includes information describing a transaction between an entity to whom a document is to be delivered and a representative.

28. A remotely initiated document fulfillment system according to claim 20, wherein said document delivery means further for transmitting reports to third parties, said reports associated with the delivery of a document.

29. A remotely initiated document fulfillment system, comprising:
a plurality of document request devices, said devices including a personal digital assistant, the personal digital assistant including a wireless transceiver, document request software, and a list of requestable documents;
a central station, the central station including a means for receiving a broadcasted document request, a document database, a fax delivery means, and an e-mail delivery means; and
a wireless communications network, said wireless communications network being communicably connected with a wireless transceiver of a document request device, said wireless communication network further being communicably connected with the central station, said wireless communications network passing communications between the central station and a document request device.

30. A remotely initiated document delivery system according to claim 29, wherein the central station further comprises a document delivery reporting means, said document delivery reporting means for delivering a report associated with the delivery of a document to a third party.

31. A remotely initiated document fulfillment system, comprising:
a plurality of document request devices, said devices including a personal digital assistant, the personal digital assistant including a cellular transceiver, document request software, and a list of requestable documents;
a central station, the central station including a means for receiving a broadcasted document request, a document database, a fax delivery means, and an e-mail delivery means, wherein the means for receiving a broadcasted document request comprises an interface to a publicly switched telephone network; and
a cellular network, said cellular network being communicably connected with the cellular transceiver of a document request device, said cellular network further being communicably connected with the central station by a publicly switched telephone network, said cellular network passing communications between the central station and a document request device.

32. A remotely initiated document delivery system according to claim 21, wherein the central station further comprises a document delivery reporting means, said document delivery reporting means for delivering a report associated with the delivery of a document to a third party.

33. A remotely initiated document fulfillment system, comprising:
a plurality of document request devices, said devices including a personal digital assistant, the personal digital assistant including a wireless transceiver, document request software, and a list of requestable documents;
a central station, the central station including a means for receiving a broadcasted document request, a document database, a fax delivery means, and an e-mail delivery means, wherein the means for receiving a broadcasted document request comprises an Internet interface; and
a wireless communications network, said wireless communications network being communicably connected with a wireless transceiver of a document request device, said wireless communication network further being communicably connected with the central station by the Internet, said wireless communications network passing communications between the central station and a document request device.

34. A remotely initiated document delivery system according to claim 33, wherein the central station further comprises a document delivery reporting means, said document delivery reporting means for delivering a report associated with the delivery of a document to a third party.

35. A remotely initiated document fulfillment system, comprising:
a plurality of document request devices, said devices including an application specific device, the application specific device including a wireless transceiver, document request software, application specific software, and a list of requestable documents;
a central station, the central station including a means for receiving a broadcasted document request, a document database, a fax delivery means, and an e-mail delivery means; and
a wireless communications network, said wireless communications network being communicably connected with a wireless transceiver of an application specific device, said wireless communication network further being communicably connected with the central station, said wireless communications network passing communications between the central station and a document request device.

36. A remotely initiated document delivery system according to claim 35, wherein the central station further comprises a document delivery reporting means, said document delivery reporting means for delivering a report associated with the delivery of a document to a third party.

37. A remotely initiated document fulfillment system, comprising:
a plurality of document request devices, said devices comprising a application specific device, the application specific device including a cellular transceiver, document request software, application specific software, and a list of requestable documents;
a central station, the central station including a means for receiving a broadcasted document request, a document database, a fax delivery means, and an e-mail delivery means, wherein the means for receiving a broadcasted document request comprises an interface to a publicly switched telephone network; and
a cellular network, said cellular network being communicably connected with the cellular transceiver of a document request device, said cellular network further being communicably connected with the central station by a publicly switched telephone network, said cellular network passing communications between the central station and a document request device.

38. A remotely initiated document delivery system according to claim 37, wherein the central station further comprises a document delivery reporting means, said document delivery reporting means for delivering a report associated with the delivery of a document to a third party.

39. A remotely initiated document fulfillment system, comprising:
a plurality of document request devices, said devices comprising at least one application specific device, the application specific device including a wireless transceiver, document request software, application specific software, and a list of requestable documents;
a central station, the central station including a means for receiving a broadcasted document request, a document database, a fax delivery means, and an e-mail delivery means, wherein the means for receiving a broadcasted document request comprises an Internet interface; and
a wireless communications network, said wireless communications network being communicably connected with a wireless transceiver of a document request device, said wireless communication network further being communicably connected with the central station by the Internet, said wireless communications network passing communications between the central station and a document request device.

40. A remotely initiated document delivery system according to claim 39, wherein the central station further comprises a document delivery reporting means, said document delivery reporting means for delivering a report associated with the delivery of a document to a third party.

41. A method for providing a remotely initiated document request fulfillment service, comprising the steps of:
identifying a document being requested;
determining a delivery method for transmitting the desired document to a delivery destination;
determining a delivery destination for delivering the desired document;
transmitting the document request to a central station, said document request identifying the requested document and the destination for the document, said transmission utilizing a wireless transmission from the document request device;
receiving said document request at a central station;
transmitting to the document request device a verification that the document request has been received; and
transmitting the requested document to the delivery destination associated with the document request.

42. A method for providing a remotely initiated document request fulfillment service according to claim 41, further comprising the steps of:
determining whether requester certification is required before the desired document can be transmitted; and
when requester certification is required before the desired document can be transmitted, obtaining from the requester a certification for the request.

43. A method for providing a remotely initiated document request fulfillment service according to claim 41, further comprising the steps of:
transmitting to the document request device a verification that the requested document has been transmitted to the delivery destination after the document has been transmitted to the delivery destination.

44. A method for providing a remotely initiated document request fulfillment service according to claim 41, wherein the method further comprises the steps of:
the central station determining whether the requested document should be modified in accordance with information associated with the document request;
when the requested document should be modified, modifying the requested document based on information associated with the delivery destination.

45. A method for providing a remotely initiated document request fulfillment service according to claim 41, wherein the method further comprises the steps of:
the central station determining whether the requested document should be modified in accordance with information associated with the document request;
when the requested document should be modified, modifying the requested document based on information associated with a transaction between a representative and an entity associated with the delivery destination.

46. A method for providing a remotely initiated document request fulfillment service according to claim 41, wherein the method further comprises the steps of:
the central station determining whether the requested document should be modified in accordance with information associated with the document request;
when the requested document should be modified, modifying the requested document based on information associated with an entity associated with the delivery destination.

47. A method for providing a remotely initiated document request fulfillment service according to claim 41, wherein the step of transmitting the requested document to the delivery destination comprises generating a facsimile transmission of the requested document, and transmitting the facsimile transmission to a fax machine.

48. A method for providing a remotely initiated document request fulfillment service according to claim 41, wherein the step of transmitting the requested document to the delivery destination comprises generating a facsimile transmission of the requested document, and transmitting the facsimile transmission to a destination address, wherein the delivery destination is an Internet address.

49. A method for providing a remotely initiated document request fulfillment service according to claim 41, wherein the step of transmitting the requested document to the delivery destination comprises generating an e-mail transmission of a copy of the requested document, and transmitting the transmission to an e-mail address, said transmission being transmitted via the Internet.

50. A method for providing a remotely initiated document request fulfillment service according to claim 41, wherein the step of transmitting the document request to a central station further comprises the steps of:
broadcasting the document request to a wireless communications network; and
relaying the broadcasted document request to a central station via the wireless communications network.

51. A method for providing a remotely initiated document request fulfillment service according to claim 41, wherein the step of transmitting the document request to a central station further comprises the steps of:
broadcasting the document request to a wireless communications network; and
receiving the broadcasted document request at the wireless communications network; and
relaying the received broadcasted document request to a central station via a publicly switched telephone network.

52. A method for providing a remotely initiated document request fulfillment service according to claim 41, wherein the step of transmitting the document request to a central station further comprises the steps of:
broadcasting the document request to a wireless communications network; and
receiving the broadcasted document request at the wireless communications network; and
relaying the received broadcasted document request to a central station via a computer network.

53. A method for providing a remotely initiated document request fulfillment service according to claim 52, wherein the computer network is the internet.

54. A method for providing a remotely initiated document request is fulfillment service according to claim 41, further comprising the step of transmitting a document delivery report to a third party.

55. A method for providing a remotely initiated document request fulfillment service according to claim 54, wherein the step of transmitting a document delivery report to a third party comprises informing a regulatory entity of th e delivery of a restricted delivery document.

56. A document delivery fulfillment service according to claim 54, wherein the step of transmitting a document delivery report comprises informing a follow-up representative of the delivery of the requested document to a destination.
